(19) United States
(12) Patent Application Publication
(10) Pub. No.: US 2004/0039632 A1
(43) Pub. Date: Feb. 26, 2004

(54) Manless parking control system and method

(76) Inventors: Myoung-Kook Han, Seoul (KR); Duk-Soo Kim, Gyeonggi-do (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/399,475

(22) PCT Filed: Oct. 18, 2001
(86) PCT No.: PCT/KR01/01755

(30) Foreign Application Priority Data
Oct. 19, 2000 (KR) 2000/61754

(51) Int. Cl. G06F 17/60

(52) U.S. Cl. 705/13; 340/5.7

(57) ABSTRACT

A manless parking control system and method is capable of automatically recognizing the arrival and leaving of a vehicle in a predetermined parking area and then automatically charging hourly parking fees to the vehicle driver, through the use of image recognition and wireless communication techniques. The manless parking control system include a camera for taking picture of a predetermined parking area to recognize the arrival and leaving of a vehicle and then for transmitting signals indicative of the result of recognition, a driver-operated wireless settlement terminal for transmitting signals indicative of the identification number of the parking area occupied by the vehicle and a driver's personal settlement information, and a parking control server for receiving the signals from the camera and the wireless settlement terminal to calculate and charge parking fees to the driver of the vehicle which has used the predetermined paring area.

### TECHNICAL FIELD

The present invention relates to a manless parking control system and method, and more particularly to a manless parking control system and method capable of automatically recognizing the arrival and leaving of a vehicle in a predetermined parking area and then automatically charging hourly parking fees to the vehicle driver, through the use of image recognition and wireless communication techniques.

### BACKGROUND ART

In a general parking lot such as a curbside parking lot and a public parking lot, several parking managers reside in the parking lot, while manually recording the times of initiating and ending the parking of a vehicle and directly collecting the parking fees from the driver of the vehicle when the vehicle leaves the parking lot.

The method of controlling a general parking lot as described above is problematic, in that not only too many persons are necessary, but also the parking managers are apt to make a mistake in recording the parking time and to embezzle the parking fees.

Therefore, in order to overcome the problems as described above in the conventional method of controlling a parking lot, developed has been an automatic system, in which coils or sensors for detecting a vehicle are disposed at every partition lines, so as to keep watch on the entrance and exit of vehicles.

However, the conventional automatic parking system as described above is also problematic, in that too much expense is necessary in initially installing, maintaining and repairing the facilities.

### DISCLOSURE OF THE INVENTION

Therefore, the present invention has been made in order to overcome the above-mentioned problems of the prior arts, and it is an object of the present invention to provide a manless parking control system and method, which is capable of automatically recognizing the arrival and leaving of a vehicle in a predetermined parking area and then automatically charging or collecting hourly parking fees to the vehicle driver, through the use of image recognition and wireless communication techniques.

According to an aspect of the present invention, there is provided a manless parking control system for controlling a parking lot including parking areas, each of which is provided with a serial parking area number, the parking control system comprising: a camera for taking picture of each of the parking areas, detecting entry and exit of a vehicle in and from each of the parking areas through an image recognition for photographed image data, and transmitting a detection signal corresponding to the entry and exit of a vehicle together with the serial parking number; a wireless settlement terminal disposed at a predetermined location in the parking lot for transmitting credit card information and a membership identification code, together with the parking area number inputted by a driver of the vehicle; and a parking control server for storing membership identification codes and settlement information of a plurality of members of the parking lot, receiving the detection signal and the parking area number to record existence or absence of a vehicle in each of the parking areas, and charging a parking fee based on one of the credit card information and the settlement information corresponding to the membership identification code received from the wireless settlement terminal.

According to another aspect of the present invention, there is provided a manless parking control method by use of a manless parking control system including a camera containing an image recognition module capable of recognizing a vehicle from photographed image data, a wireless settlement terminal capable of inputting a parking area number and a membership identification code, reading credit card information, and transmitting credit card information and the membership identification code, together with the parking area number inputted, and a parking control server for storing membership information inclusive of the membership identification codes and settlement information of a plurality of members of a parking lot, determining whether a vehicle exists in each parking area, and charging a parking fee, the manless parking control method comprising the steps of: (a) detecting entry and exit of the vehicle in and from each parking area by the camera, and transmitting a vehicle entry and exit detection signal together with a parking area number for the parking area; (b) when a parking detection signal for a new vehicle together with the corresponding parking area number is received from the camera, recording the parking area number and a parking start time; (c) receiving and recording one of the credit card information and the membership identification code together with the parking area number inputted by the driver from the wireless settlement terminal, and, when one of the credit card information and the membership identification code for a parking area in which the vehicle is parked is not received from the wireless settlement terminal within a predetermined time period, informing a parking manager of the unauthorized parking together with the parking area number; and, (d) when a vehicle exit detection signal for a parked vehicle together with the corresponding parking area number is received from the camera, estimating a total parking time from the recorded parking start time up to the time of receiving the vehicle exit detection signal, calculating the parking fee for the total parking time, and charging the parking fee based on one of the credit card information and the settlement information corresponding to the membership identification code.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram for showing a general construction of a manless parking control system according to the present invention;

FIG. 2 is a view for showing an example of various tables contained in a parking database of a parking control server employed in the manless parking control system shown in FIG. 1;

FIG. 3 is a flowchart of a manless parking control method according to another preferred embodiment of the present invention; and

FIG. 4 is a flowchart for showing the parking fee settlement process according to the present invention.

### BEST MODE FOR CARRYING OUT THE INVENTION

Preferred embodiments of the present invention will now be described with reference to the attached drawings.

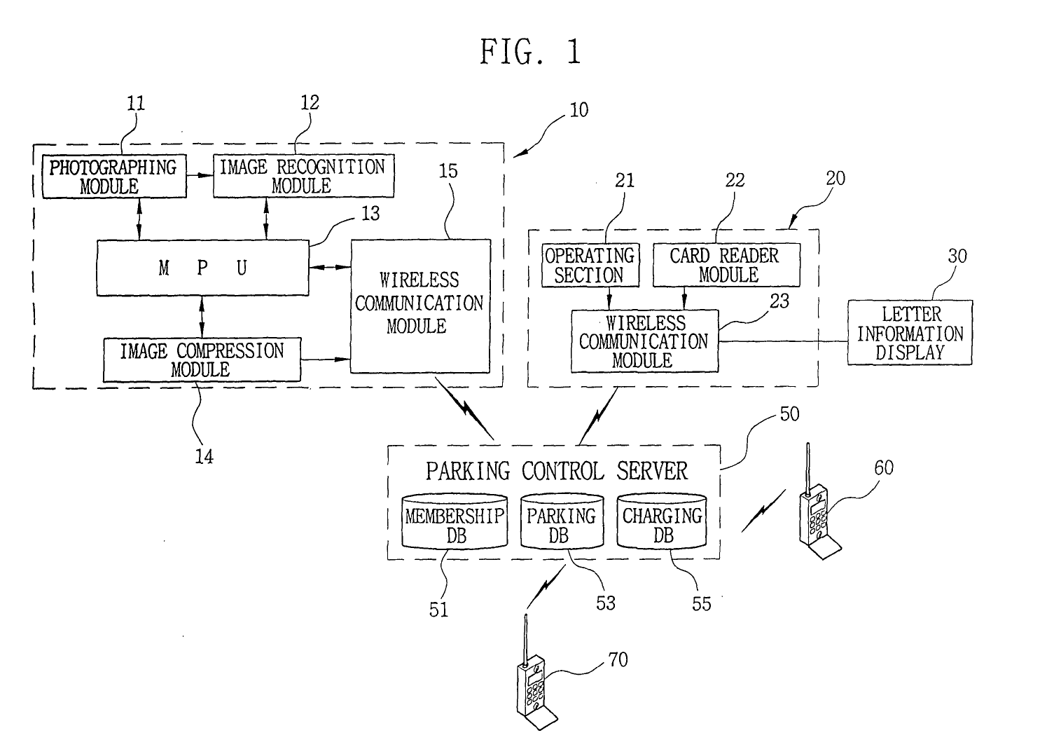

Referring to FIG. 1, which is a block diagram showing a general construction of a manless parking control system according to the present invention, the manless parking control system includes a camera 10, a wireless settlement terminal 20, a letter information display 30, a parking control server 50, a user terminal 60, and a manager terminal 70. In this case, the camera 10, the wireless settlement terminal 20, and the letter information display 30 are disposed at predetermined locations in a parking lot, while the parking control server 50 is disposed in a place distanced from the parking lot.

Primary functions of the components enumerated above will be set forth with reference to FIG. 1. First of all, the camera 10 is a means disposed at a predetermined location in the parking lot, for continuously taking a picture of a predetermined parking area at the predetermined location. In this case, a plurality of cameras may be distributed over an entire area of the parking lot. As shown in FIG. 1, the camera 10 includes a photographing module 11, an image recognition module 12, a main processor unit (MPU) 13, an image compression module 14, and a wireless communication module 15.

The photographing module 11 includes an image photographing means such as an optic system and CCD, various filters for night photographing, and a light amplifying lens. The photographing module 11 continuously or periodically takes a picture of a predetermined parking sector in a parking lot.

The image recognition module 12 is a means for recognizing a vehicle in the predetermined parking area by analyzing digital image data photographed by the photographing module 11. An algorithm and various data for recognizing a vehicle are stored in a form of programs in the image recognition module 12. According to an example of such an algorithm for recognizing a vehicle as above, an object is continuously taken a picture of with a predetermined interval, while a present picture is compared with a previous picture, so as to determine if there is any change between the pictures, thereby detecting a moving object. Then, it is determined if the moving object is a vehicle or not, so that an entry and exit of the vehicle can be recognized. In order to carry out the above process, the image recognition module 12 pre-stores reference image data for the shape of a vehicle and the parking sector, and estimates the rate between the reference image data and data corresponding to a predetermined portion in the taken pictures, so as to determine whether there exists a vehicle or not. The above description is about only an extremely fragmentary example of the image recognition technology, and the above process may be easily carried out by means of a more highly developed image recognition technology, which is currently being spread.

The MPU 13 shown in FIG. 1 is a control processor for controlling the entire function of the camera 10. The MPU 13 controls operation of components in the camera 10 and data transmission between the components. Especially, the MPU 13 transmits a result of the process of recognizing a vehicle, which has been carried out by the image recognition module 12, through the wireless communication module 15 which will be described later. When the image recognition module 12 does not normally recognize a vehicle, the image data photographed by the photographing module 11 are compressed by the image compression module 14, and then the compressed data are transmitted by wireless through the wireless communication module 15. In this case, although the photographed image data are transmitted through the wireless communication module 15 by wireless in the present embodiment shown in FIG. 1, the image data may be transmitted through a wire network to the parking control server 50 which will be described later.

The image compression module 14 compresses the image data photographed by the photographing module 11 under the control of the MPU 13 into data, which can be transmitted in real time by means of a preset frequency band, through a predetermined compression process. The wireless communication module 15 transmits the image data compressed by the image compression module 14 or the result of recognition by the image recognition module 12 under the control of the MPU 13 by wireless.

In the meantime, the wireless settlement terminal 20 shown in FIG. 1 is a means for automatically carrying out settlement of parking fees and confirmation of a driver's identity, which is disposed at a fixed structure in a curbside parking lot or a gateway of a parking lot. In the case of a driver already registered in the parking control server 50 which will be described later, the driver inputs the number of the parking area, in which the driver's vehicle is parked, and the driver's identification code through the wireless settlement terminal 20. In contrast, in the case of a driver not registered in the parking control server 50, the driver can settle the parking fee through the wireless settlement terminal 20 utilizing such means as a credit card. Therefore, the wireless settlement terminal 20 includes an operating section 21, by which a driver can input the-number of parking area and the drivers' identification code, a card reader module 22 which can read a credit card, and a wireless communication module 23 capable of wirelessly transmitting data generated by the operating section 21 and the card reader module 22.

The letter information display 30 displays parking information such as an area and its location in which a vehicle is parked in the form of letters, so that a user of the parking lot can refer to the letter information display 30. Such parking information is transmitted to the parking control server 50 which will be described later. Therefore, although the letter information display 30 also requires a wireless communication module capable of receiving data by wireless from the parking control server 50, the letter information display 30 can share the wireless communication module 23 in the wireless settlement terminal 20 since the letter information display 30 is connected with the wireless settlement terminal 20 by wire in the present embodiment.

The parking control server 50 is a means for generally controlling and managing the operation of a manless parking control system according to the present invention, and includes a storing means for storing image data provided by the camera 10, an image recognition module capable of recognizing a vehicle from the received image data, etc. In this case, the image recognition module contained in the parking control server 50 has a function nearly equal to that of the image recognition module included in the camera 10, except that the former stores more precise algorithm and more reference image data than the latter so that it can perform a more precise operation in recognizing a vehicle.

Further, the parking control server 50 calculates and charges parking fees on the basis of settlement data provided from the wireless settlement terminal 20, and informs it to the manager terminal 70 when there is a vehicle without settling its parking fee.

In order to carry out the functions as described above, the parking control server 50 includes various types of databases, that is, the parking control server 50 includes a membership database 51 containing members' information such as names, mobile phone numbers, addresses, and settlement account numbers of a plurality of members of the parking lot, a parking database 53 containing the parking information according to the image data and the received vehicle recognition result provided by the camera 10, and a charge database 55 containing charging information, such as a parking fee, parking time, and settlement means, for users of the parking lot.

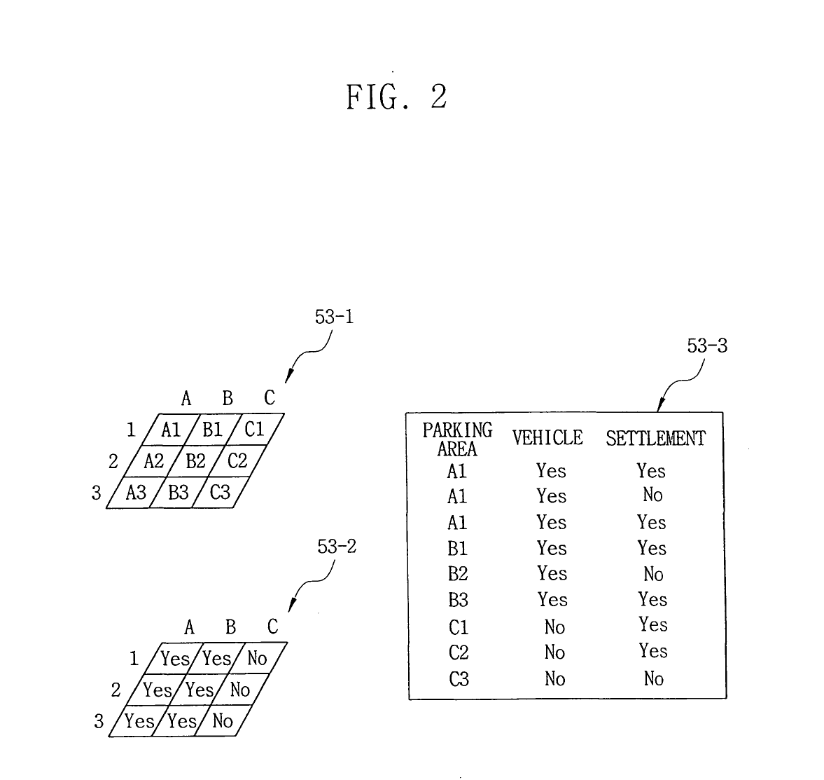

FIG. 2 shows an example of tables contained in the parking database 53 of the parking control server 50 as described above, including a parking area table 53-1, a vehicle existence/absence table 53-2, and a parking information table 53-3.

Referring to FIG. 2, the parking area table 53-1 is a kind of an electronic positional relation diagram, a data table in which information for parking areas in the parking lot is stored, and the vehicle existence/absence table 53-2 is a data table in which existence and absence of a vehicle in each parking area in the parking area table 53-1 are recorded. Further, the parking information table 53-3 is a table in which real time parking information produced by synthesizing data from the parking area table 53-1 and the vehicle existence/absence table 53-2 is recorded.

The parking control server 50 transmits the parking information from the parking database 53, that is, information including areas in which vehicles can be parked, locations of the areas, etc., to the wireless settlement terminal 20 described above through a wireless communication network (not shown), so that the parking information can be displayed on the letter information display 30 connected with the wireless settlement terminal 20.

Meanwhile, the user terminal 60 and the manager terminal 70 shown in FIG. 1 transmit and receive data to and from the parking control server 50 by wireless, and may be a usual mobile communication terminal or a wireless personal digital assistant (PDA). Therefore, in a manless parking control system according to the present invention, in order to transmit and receive data to and from the camera 10, the wireless settlement terminal 20, the user terminal 60, and the manager terminal 70 by wireless, the parking control server 50 must have its own wireless communication network or must be able to be connected with the existing mobile communication network. Since such communication networks can be easily achieved within the scope of the present invention, in consideration of, for example, expense for equipments when the system is designed, a detailed description about them will be omitted in the present embodiment.

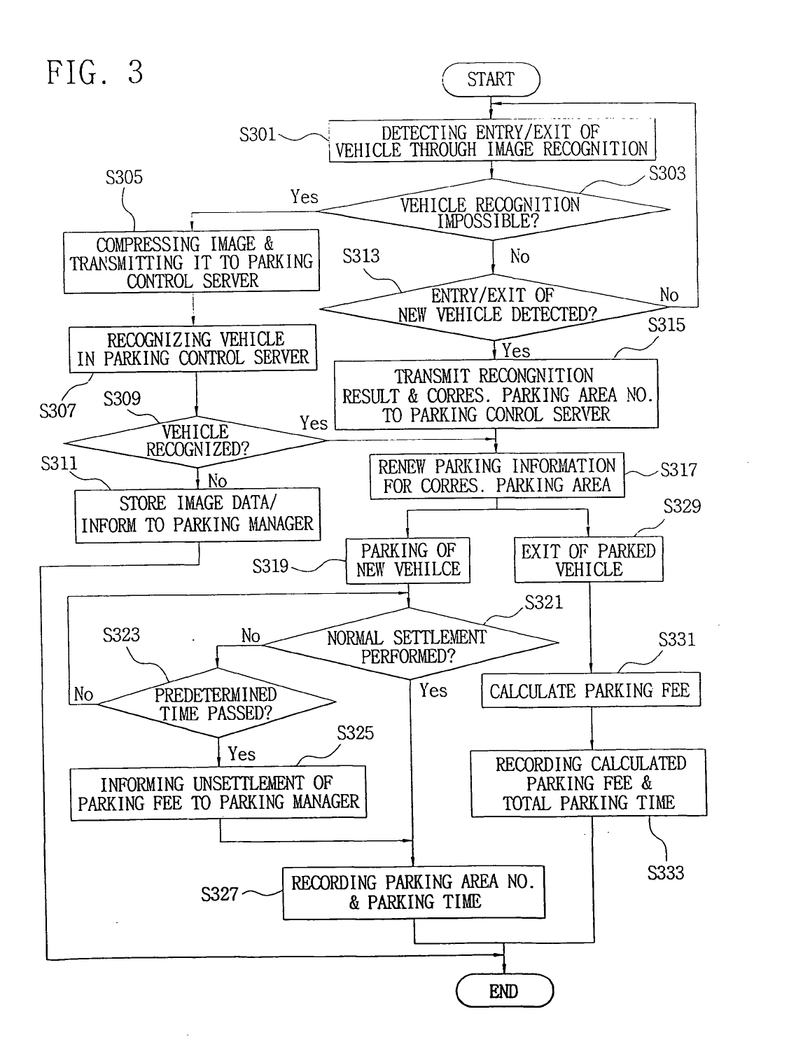

FIG. 3 is a flowchart of a manless parking control method according to another preferred embodiment of the present invention, a series of steps of which will be described in detail hereinafter.

In a state that each parking area in a parking lot is provided with a parking area number in a form of serial numbers, the camera 10 disposed at a predetermined location in the parking lot continuously or periodically takes a picture of a predetermined parking area, and detects entry and exit of vehicles through an image recognition process for the photographed images (step S301).

Although a new subject has been detected through the above image recognition process, when a normal recognition of a vehicle is impossible due to such reasons as a low screen quality of the photographed image (step S303), the camera 10 compresses the photographed image through a predetermined compression process, and then transmits it to the parking control server 50 (step S305).

Thereafter, the parking control server 50 carries out a more precise process of recognizing a vehicle for the image data transmitted from the camera 10 (step S307), so as to determine whether a detected subject is a vehicle or not (step S309). When it is also impossible to recognize a vehicle from the photographed image even by the parking control server 50, the image data received from the camera 10 is stored and then the impossibility is reported to the manager terminal 70, so that the parking manager can properly cope with the report (step S317). On the contrary, when a vehicle is recognized, the process proceeds from step S317 which will be described later.

In the meantime, after step S303, when an entry or exit of a new vehicle is recognized through a normal recognition process for a vehicle (step S313), the camera 10 transmits the number of the corresponding parking area and the vehicle recognition result to the parking control server 50 by wireless (step S315).

Therefore, the parking control server 50 renews the parking information (including existence or absence of a vehicle) for the corresponding parking area according to the vehicle recognition result provided by the camera 10 (step S317). In this case, the process after step S317 becomes different depending on whether the recognition result provided by the camera 10 shows an entry of a new vehicle or an exit of a parked vehicle.

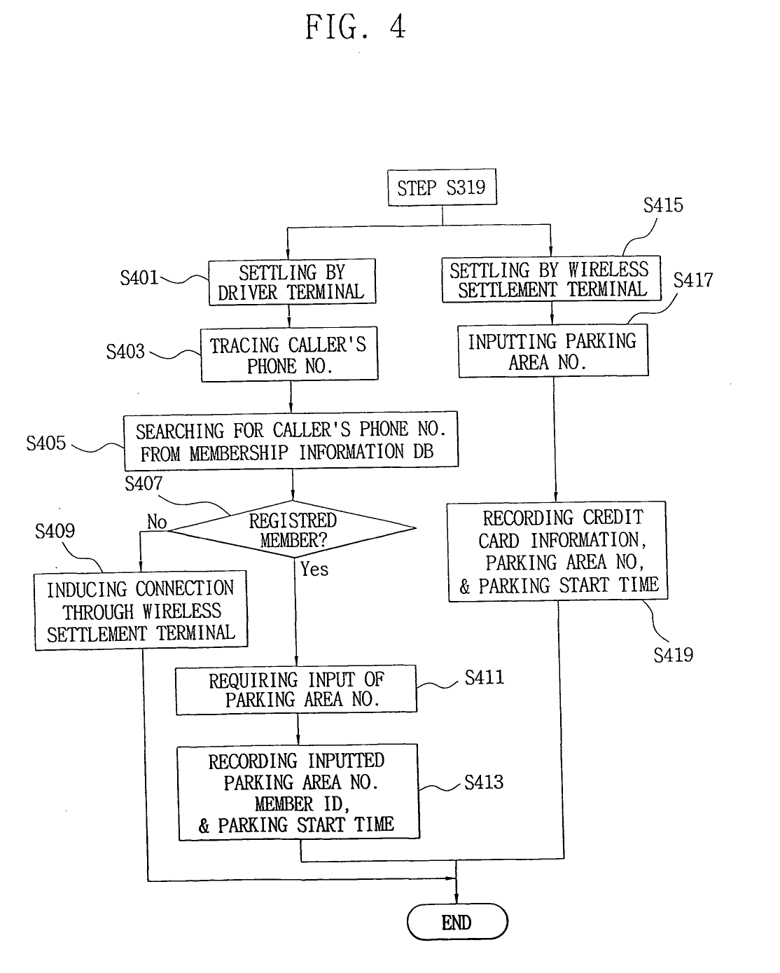

First, when a new vehicle enters the parking area (step S319), the parking database 53 is renewed in such a manner as that an existence of a vehicle (‘Yes’) is recorded for the corresponding parking area, and then whether the driver carries out a normal parking fee settlement process or not is watched (step S321). Such a parking fee settlement process will be described later in detail with reference to FIG. 4.

When the driver does not carry out a normal parking fee settlement process within a predetermined time, for example, within ten minutes (step S323), the parking control server 50 transmits a predetermined message for informing the unsettlement of the parking fee together with the number of the corresponding parking area to the manager terminal 70 (step S325), so that the parking manager can properly cope with it.

In contrast, when the driver has normally carried out the parking fee settlement process within the predetermined time, the parking control server 50 records the parking fee settlement information, the parking time, etc., for the corresponding parking area, in the charge database 55 (step S327).

In the meantime, according to the vehicle recognition result provided by the camera 10 in step S315, when a parked vehicle exits from the parking area (step S329), the parking control server 50 renews the parking database 53 so as to record a parking completion (‘No’) for the corresponding parking area and calculate and record the parking fee. That is, the total parking time from the time of initiating the parking, which is recorded when the vehicle is parked in step S327, to the time when the parking is ended is estimated, so that the parking fee is calculated (step S333).

Further, the parking fee calculated through the process as described above can be automatically collected through a settlement means selected by the driver, such as a credit card and a giro payment (a kind of bank payment), after being accumulated and charged by the unit of a predetermined time period, for example, one month.

Meanwhile, FIG. 4 is a flowchart for showing the parking fee settlement process carried out in step S321. According to the present invention, the parking fee settlement process can be classified into two cases where the settlement is automatically carried out through the driver terminal 60 and where the settlement is carried out through the wireless settlement terminal 20 disposed at a predetermined location in the parking lot, and the former case of utilizing the driver terminal 60 is employed when the driver is a member already registered in the parking control server 50.

A more detailed description about the two cases will be given hereinafter.

When the driver is a member already registered in the parking control server 50, the driver utilizes the driver terminal 60 to connect with the parking control server 50 through a phone call, thereby settling the parking fee (step S401). Then, the parking control server 50 traces the caller's phone number (step S403), so as to search the membership database 51 for member's information corresponding to the caller's phone number or the driver's phone number (step S405).

Further, whether the diver is an already registered member or not is determined on the basis of the searched result for the information corresponding to the caller's phone number (step S407). When there is no searched member's information corresponding to the caller's phone number, a predetermined guide message for inducing the driver to carry out a settlement by means of a credit card through the wireless settlement terminal 20 disposed at a predetermined location in the parking lot is transmitted to the driver terminal 60 (step S409).

On the contrary, when the driver is determined as a member registered in the parking control server 50 in step S407, the parking control server 50 transmits a predetermined guide message indicating the driver to input the parking location of the vehicle, that is, the number of the parking area, in which the vehicle was parked, to the driver terminal 60 (step S411). When the number of the parking area has been inputted from the driver terminal 60 in response to the predetermined guide message, the parking control server 50 records the searched driver's identification code or individual number, the number of the parking area, the parking start time (the current time), etc., in the charge database 55 (step S413), thereby completing the parking fee settlement process.

In the meantime, in the case where the driver is not a member registered in the parking control server 50 or when the drive doesn't have the driver terminal 60 even though the driver is a member registered in the parking control server 50, the driver can utilize the wireless settlement terminal 20 disposed at a predetermined location in settling the parking fee (step S415). In this case, the parking control server 50 transmits through the user terminal 60 a predetermined guide message indicating the driver to input the number of the parking area, in which the vehicle was parked, and then input the driver's membership identification code or insert or contact the driver's credit card in or with the wireless settlement terminal 20, so as to carry out a credit card settlement (step S417).

Therefore, the driver can input the number of the parking area through the user terminal 60. Thereafter, the driver can try the settlement of the parking fee by inputting the membership identification code in the case where the driver is a member registered in the parking control server 50 or by inserting or contacting a credit card in or with the wireless settlement terminal 20 in the case where the driver is not a member registered in the parking control server 50. In this case, the parking control server 50 receives the number of the parking area and the membership identification code or the credit card information through the wireless settlement terminal 20, and records them together with the parking start time (the current time) in the charge database 55 (step S419), so as to charge the parking fee corresponding to the total parking time when the parking is ended to a credit card company.

In result, by means of the processes shown in FIGS. 3 and 4, not only the entry and exit of a vehicle can be automatically detected, but also the settlement of the parking fee can be automatically proceeded with, so that a manless parking control service is enabled.

### INDUSTRIAL APPLICABILITY

As can be seen from the foregoing, the present invention provides a manless parking control system and method capable of automatically recognizing the arrival and leaving of a vehicle in a predetermined parking area and then automatically charging parking fees to the vehicle driver, thereby reducing expense for managing and controlling a parking lot.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A manless parking control system for controlling a parking lot including parking areas, each of which is provided with a serial parking area number, the parking control system comprising:
a camera for taking picture of each of the parking areas, detecting entry and exit of a vehicle in and from each of the parking areas through an image recognition for photographed image data, and transmitting a detection signal corresponding to the entry and exit of a vehicle together with the serial parking number;
a wireless settlement terminal disposed at a predetermined location in the parking lot for transmitting credit card information and a membership identification code, together with the parking area number inputted by a driver of the vehicle; and
a parking control server for storing membership identification codes and settlement information of a plurality of members of the parking lot, receiving the detection signal and the parking area number to record existence or absence of a vehicle in each of the parking areas, and charging a parking fee based on one of the credit card information and the settlement information corresponding to the membership identification code received from the wireless settlement terminal.

2. A manless parking control system as recited in claim 1, wherein the camera comprises:
a photographing module for continuously or periodically taking a picture of each of the parking areas;
an image recognition module containing an image recognition algorithm adapted to recognize the vehicle from the photographed image data and then generate the detection signal;
a communication module capable of transmitting and receiving data;
an image compression module for compressing the image data through a predetermined compression process; and
a main processor unit for controlling the communication module to transmit the detection signal, and, when the image recognition module fails to recognize the vehicle, controlling the image compression module to compress the photographed image data and controlling the communication module to transmit compressed image data.

3. A manless parking control system as recited in claim 1, wherein the wireless settlement terminal comprises:
an operating section, by which the driver can input the parking area number and the member identification code;
a card reader module for reading the credit card information; and
a wireless communication module for transmitting one of the read credit card information and the membership identification code together with the parking area number inputted through the operating section.

4. A manless parking control system as recited in claim 1, wherein, when the credit card information and the membership identification code are not received from the wireless settlement terminal within a predetermined time period after a parking is made, the parking control server is adapted to determine that the vehicle is parked without permission and then inform a parking manager of the unauthorized parking together with the number of the parking area in which the vehicle is parked without permission.

5. A manless parking control system for controlling a parking lot including parking areas, each of which is provided with a serial parking area number, the parking control system comprising:
a camera for taking picture of each of the parking areas, detecting entry and exit of a vehicle in and from each of the parking areas through an image recognition for photographed image data, and transmitting a detection signal corresponding to the entry and exit of a vehicle together with the serial parking number;
a driver terminal for wirelessly transmitting the parking area number inputted through a phone connection by a driver of the vehicle; and
a parking control server for storing membership information including mobile phone numbers and settlement information of a plurality of members of the parking lot, receiving the detection signal and the parking area number to record existence or absence of a vehicle in each of the parking areas, and, when the driver terminal is connected and the parking area number is received, tracing a caller's phone number for the driver terminal and searching for the membership information corresponding to the caller's phone number so as to charge a parking fee.

6. A manless parking control method by use of a manless parking control system including a camera containing an image recognition module capable of recognizing a vehicle from photographed image data, a wireless settlement terminal capable of inputting a parking area number and a membership identification code, reading credit card information, and transmitting credit card information and the membership identification code, together with the parking area number inputted, and a parking control server for storing membership information containing membership identification codes and settlement information of a plurality of members of a parking lot, determining whether a vehicle exists in each parking area, and charging a parking fee, the manless parking control method comprising the steps of:
(a) detecting entry and exit of the vehicle in and from each parking area by the camera, and transmitting a vehicle entry and exit detection signal together with a parking area number for the parking area;
(b) when a parking detection signal for a new vehicle together with the corresponding parking area number is received from the camera, recording the parking area number and a parking start time;
(c) receiving and recording one of the credit card information and the membership identification code together with the parking area number inputted by the driver from the wireless settlement terminal, and, when one of the credit card information and the membership identification code for a parking area in which the vehicle is parked is not received from the wireless settlement terminal within a predetermined time period, informing a parking manager of the unauthorized parking together with the parking area number; and
(d) when a vehicle exit detection signal for a parked vehicle together with the corresponding parking area number is received from the camera, estimating a total parking time from the recorded parking start time to the time of receiving the vehicle exit detection signal, calculating the parking fee corresponding to the total parking time, and charging the parking fee based on one of the credit card information and the settlement information corresponding to the membership identification code.

7. A manless parking control method by use of a manless parking control system including a camera containing an image recognition module capable of recognizing a vehicle from photographed image data, and a parking control server for storing membership information containing mobile phone numbers and settlement information of a plurality of members of a parking lot, determining whether a vehicle exists in each parking area, and charging a parking fee, the manless parking control method comprising the steps of:
(a) detecting entry and exit of the vehicle in and from each parking area by the camera, and transmitting a vehicle entry and exit detection signal together with a parking area number for the parking area;
(b) when a parking detection signal for a new vehicle together with the corresponding parking area number is received from the camera, recording the parking area number and a parking start time;
(c) when a mobile communication terminal of a driver of the vehicle is connected and the parking area number is received, tracing a caller's phone number for the mobile communication terminal and searching for the member information corresponding to the caller's phone number, so as to charge the parking fee, and, when the parking area number is not received from the mobile communication terminal within a predetermined time period, informing a parking manager of the unauthorized parking together with the number of the parking area in which the vehicle is parked without permission; and
(d) when a vehicle exit detection signal for a parked vehicle together with the corresponding parking area number is received from the camera, estimating a total parking time from the recorded parking start time up to the time of receiving the vehicle exit detection signal, calculating the parking fee corresponding to the total parking time, and charging the parking fee based on the settlement information contained in the membership information.
